(19) United States
(12) Patent Application Publication
(10) Pub. No.: US 2003/0110833 A1
(43) Pub. Date: Jun. 19, 2003

(54) Perforation detection method

(76) Inventor: Karlo Ivan Jolic, Ascot Vale Victoria (AU)

Correspondence Address: Welsh & Katz, 22nd Floor, 120 South Riverside Plaza, Chicago, IL, 60606-3913, US

(21) Appl. No.: 10/240,492

(22) PCT Filed: Apr. 4, 2001
(86) PCT No.: PCT/AU01/00378

(30) Foreign Application Priority Data
Apr. 4, 2000 (AU) PQ 6678

(51) Int. Cl. G01M 3/04; G08B 21/00

(52) U.S. Cl. 73/40; 340/605

(57) ABSTRACT

A method of detecting perforations in a portion of a substantially electrically non-conducting package (1) which contains an electrically conducting material, the method comprising the steps of: (a) immersing the portion (2) of the package to be tested in an electrolyte solution (3); (b) contacting a substantial amount of non-immersed package surface with an electrical conductor (5); (c) electrically connecting a first terminal of an AC electrical power source (6) to the electrical conductor and a second terminal to the electrolyte solution and including a resistor (7) in electrical connection either between the first terminal and the electrical conductor or between the second terminal and the electrolyte solution; (d) measuring voltage reduction across the resistor or measuring current flow and comparing it with a threshold value such that if the voltage reduction or current exceeds the threshold value, perforation of the tested portion of the package is indicated.

### FIELD OF THE INVENTION

The present invention relates to a method of detecting perforations within electrically non-conducting packages which contain an electrically conducting material.

### BACKGROUND OF THE INVENTION

There are many contexts in which it is useful to be able to determine, for example for safety or quality control purposes, whether the packaging of a product or material is perforated. For example, in the case of hazardous materials such as poisonous agents, corrosive agents or flammable agents it may be of particular importance to ensure there is no perforation within the product packaging which may allow escape of hazardous materials. In the case of food products or other perishable items similar concerns may arise if product packaging contains perforations which may allow the influx of air and/or biological agents such as bacteria which may lead to spoiling of the product. It may also be advantageous in the case of foods, beverages, pharmaceutical agents or the like to be able to detect perforations in product packages which result from tampering.

U.S. Pat. No. 5,535,618 to Konieczka relates to a method of pin hole detection which is based upon the measurement of electrolytic conductance using direct current. This technique is applicable for packages made of non-conducting materials but which contain conducting contents. In this method the part of the package to be inspected for pin holes is immersed in an electrolytic bath, which creates an external electrical contact or electrode. Another electrode is connected directly to the contents of the package. By applying a DC voltage to the electrodes a current is caused to run through the circuit only in the situation where a hole is present within the package. A major disadvantage is associated with this method, however, as it is necessary for there to be direct electrical contact with the package contents. Unless the package is equipped with a specially designed electrical contact which provides an electrically conducting path from the product to the exterior of the package, the package will need to be opened. This technique is, therefore, generally not appropriate for use with perishable products, as opening of the package may be destructive to the product concerned.

U.S. Pat. No. 3,855,531 to Fielibert and Van Rooijen discloses a specially designed package which allows direct electrical contact to the package contents without opening or damaging the package. Packaging of this type is, however, not compatible with all products or manufacturing/packaging processes and also involves an increased cost relative to standard packaging arrangements.

High voltage, high frequency techniques have also been developed for detecting pin hole perforations within packages, as disclosed in U.S. Pat. No. 4,243,932 to Kakumoto, Oe and Nakagawa. The technique disclosed in this document is also applicable to packages made of insulating material which include conducting contents. This technique involves placing two electrodes in contact with the package and applying a high frequency, high voltage to the electrodes to generate a discharge current. The packaging material which separates the electrodes from the contents of the package acts as a capacitor and the dielectric properties of the capacitor are changed when the region of the package in contact with the electrodes has a perforation. This change results in an increase in the discharge current which allows the perforation to be detected. As a result of the use of high voltage, high frequency electricity this technique is quite energy and therefore cost inefficient, and has a certain level of hazard associated with it. In addition, in the case of a perforated package the contents may be compromised as a result of electrical discharge, which may mean the contents cannot be recycled.

U.S. Pat. No. 5,760,295 to Yasumoto discloses an inspection technique based upon the measurement of capacitance under low voltage, AC conditions, which is again applicable to insulating packages which include conducting contents. In this method the part of the package to be inspected is immersed in an electrolyte solution and a pair of metal plates are placed in contact with the package. One of the plates is electrically connected to the electrolyte and the capacitance between the plates is measured using a capacitance meter. A significantly larger capacitance reading is obtained when a pin hole is present in the immersed part of the package. This technique has the advantages that it is simple, non-destructive to the package contents and relatively inexpensive to operate, but the difficulty is that there is only a relatively low capacitance change associated with package perforation (relative to a standard where there is no perforation of the package). As a result, this technique does not offer particularly sensitive perforation detection so that it may fail to detect very small perforations.

With this background in mind, it is an object of the present invention to provide an improved method of detection of perforations in electrically non-conducting packages which contain an electrically conducting material. Other objects of the present invention will become apparent from the following detailed description thereof.

### SUMMARY OF THE INVENTION

According to one embodiment of the present invention there is provided a method of detecting perforations in a portion of a substantially electrically non-conducting package which contains an electrically conducting material, the method comprising the steps of:

(a) immersing the portion of the package to be tested in an electrolyte solution;

(b) contacting a substantial amount of non-immersed package surface with an electrical conductor;

(c) electrically connecting a first terminal of an AC electrical power source to the electrical conductor and a second terminal to the electrolyte solution and including a resistor in electrical connection either between the first terminal and the electrical conductor or between the second terminal and the electrolyte solution;

(d) measuring voltage reduction across the resistor or measuring current flow and comparing it with a threshold value such that if the voltage reduction or current exceeds the threshold value, perforation of the tested portion of the package is indicated.

Preferably the electrical conductor contacts at least about 15%, preferably at least about 30%, more preferably at least about 50%, still more preferably at least about 65% and particularly preferably at least about 80% of the non-immersed package surface.

In one embodiment of the invention the electrical conductor is metallic and conforms in shape to at least part of the non-immersed package surface. In another embodiment the electrical conductor is an electrically conducting brush with bristles arranged to contact at least part of the non-immersed package surface. In a further embodiment the electrical conductor is an electrically conducting paste, gel or liquid which can be applied to, or placed in contact with, at least part of the non-immersed package surface.

In a further embodiment of the present invention the electrolyte solution is retained in an electrically conducting container and the electrical connector between the second terminal, optionally via the resistor, is via the container. The electrolyte solution may for example be an aqueous solution comprising one or more of sodium ions, chloride ions, hydrogen ions, hydroxide ions, potassium ions, calcium ions, magnesium ions, iron ions, carbonate ions, nitrate ions, nitrite ions, fluoride ions, aluminium ions, phosphate ions and/or sulfate ions.

In a preferred embodiment of the invention the electrical power source supplies between about 0.5 Volts RMS and about 50 Volts RMS at a frequency of between about 0.5 kHz and about 50 kHz with resistance of the resistor being between about 50 Ohms and about 2000 Ohms. More preferably the electrical power source supplies between about 1 Volt RMS and about 10 Volts RMS at a frequency of between about 1 kHz and about 15 kHz with resistance of the resistor being between about 250 Ohms and about 750 Ohms.

### BRIEF DESCRIPTION OF THE FIGURES

FIG. 1 shows a schematic representation of one example of apparatus which may be used in the perforation detection method according to the present invention.

### DETAILED DESCRIPTION OF THE INVENTION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The method according to the present invention may be utilised for detecting perforations within packages which are substantially electrically non-conducting and which contain an electrically conducting material or product. The methods according to the invention can be used for detecting whether perforations are present within only a portion of the product at any one time. For the most efficient operation of the method there should be no head space within the portion of the package being tested, such that the material contained within the package is in contact with the entire internal surface of the portion of the package being tested. The detection method of the invention will also be more efficient where the presence of air bubbles within the material in the package is eliminated or at least reduced to a minimum. The perforation detection methods according to the invention can be utilised in relation to product packages which are produced from a broad range of materials, in a range of shapes and sizes and which include a broad range of products or materials contained therein, as long as the package and contained materials meet the requirements outlined above. Naturally also, the product and its contents should be such that they will not degrade or cause a safety hazard when an AC voltage as outlined below, is applied thereto.

Although it is possible using the methods according to the invention to detect large tears or punctures within product packaging, there may only be limited circumstances under which the present methods would be adopted in order to detect punctures or tears or the like which could readily be detected by visual inspection. Generally, the methods according to the invention will be adopted where the perforations within the package are relatively small so that they either cannot be, or cannot readily be, detected by visual inspection. The perforations which may be detected according to the present invention include minute pin pricks as well as larger holes, voids, tears or other deformities within the package which will serve to bring the contents of the package into direct electrical communication with an electrolyte solution within which a portion of the package which includes the perforation may be immersed.

Although the methods of the invention may be utilised for locating perforations within relatively rigid materials such as PET plastics and the like, the present invention is more particularly suited to flexible packaging produced from non-conducting flexible polymeric materials such as cellulosic polymers, rubber or latex polymers or other flexible plastics such as polyethylene. The methods according to the present invention find particular application in relation to the detection of perforations in sausage-like packages (also referred to as “chubs”) which comprise an outer flexible polymeric layer, typically formed as a tube, which is filled with a product and then sealed at either end with clips. This packaging type is particularly suited and often utilised for the packaging of food items such as mince meat, sausage meat, salami, pet food and the like, which in order to ensure adequate product shelf life, must be hermetically sealed. A particular concern which arises in relation to such products is the potential for the package to be perforated during filling or sealing of the package or during handling procedures, especially machine operated handling procedures.

The term “substantially electrically non-conducting package” is intended to convey that the material from which that portion of the package which is being tested for perforations is produced is essentially not an electrical conductor under the conditions of the test. As would be recognised by persons skilled in the art most materials will conduct electrical current if the applied voltage is high enough. In the present context, however, the packaging materials act effectively as insulators under the voltage/current conditions selected for conducting the perforation detection technique.

The method of the invention is suitable only for detecting perforations within the portion of the package which is immersed within an electrolyte solution. For example in the case of the sausage-like packages referred to above, the detection technique may need to be conducted at each of the sealed ends of the package where the potential exists for perforations to be caused by application of the sealing clips. In relation to other packaging types which may be processed in a different manner it may be the case that there are particular regions of the package which are similarly prone to perforation. Alternatively, it is possible to test the entirety of the package for perforations by conducting repeated tests on different package regions.

The electrolyte solution adopted in relation to the present invention is one which must conduct electrical current under the conditions adopted for the detection technique. Preferably the solvent adopted in preparation of the electrolyte solution will be water, although other solvents which are compatible with the test procedures and which do not cause degradation of the product or its packaging may be utilised. The benefits of using water are that it is readily available, non-hazardous, generally does not result in degradation of plastics materials and is compatible with use in conjunction with food products. The electrolyte solution may be prepared from salts which are compatible with the package, the container which holds the electrolyte and the product within the package being tested. Examples of suitable salts include those which in solution will form sodium ions, chloride ions, hydrogen ions, hydroxide ions, potassium ions, calcium ions, magnesium ions, iron ions, carbonate ions, nitrate ions, nitrite ions, fluoride ions, aluminum ions, phosphate ions and/or sulfate ions. It is to be understood, however, that these specific ionic species have been recited by way of example only and are not intended to be limiting upon the scope of the invention. In a particularly preferred embodiment of the invention sodium chloride will be utilised to prepare the electrolyte solution. For example the solution may have a concentration of between about 0.05 M and about 5 M, preferably between about 0.1 M and about 2 M.

The present inventors have determined that the best perforation detection results are obtain by the methods of the present invention when the surface of the non-immersed package which is contacted with an electrical conductor is maximised. Preferably therefore the electrical conductor which is brought into contact with the package surface contacts at least about 15%, preferably at least about 30%, more preferably at least about 50%, still more preferably at least about 65% and particularly preferably at least about 80% of the non-immersed package surface. It is important that the electrical conductor is not in direct electrical contact with the electrolyte solution. The electrical conductor or electrode which contacts the package may take a number of different forms such as for example a metallic plate which is shaped to conform to part of the non-immersed package surface. For example, in the case of the sausage-like packaging referred to above the electrical conductor may take the form of a metallic tube shaped to contact the package surface. Alternatively, it is possible for the electrical conductor to take the form of a brush with bristles arranged to contact at least part of the non-immersed package surface, or even for the electrical conductor to constitute an electrically conducting paste or gel which is applied to, or a liquid which is in contact with, at least part of the non-immersed package surface. For example, silica gel is an electrically conducting material which may be used in this manner.

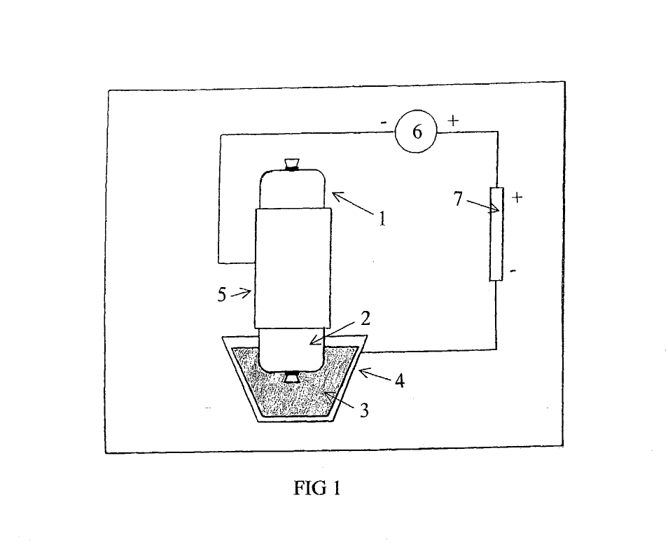

The method of the present invention requires the use of an AC electrical power source having one terminal connected to the electrical conductor and another terminal connected to the electrolyte solution. For example an applied voltage of between about 0.5 Volts and about 50 Volts RMS with frequency of between about 0.5 kHz and about 100 kHz, may be adopted. A resistor is then also incorporated within the circuit between the power source and the electrolyte solution or between the power source and the electrical conductor. Suitable resistors may for example have resistance of between about 50 Ohms and about 2000 Ohms depending upon the applied voltage. This arrangement is clearly shown in FIG. 1 where the portion 2 of the package to be tested 1 is immersed within the electrolyte solution 3. In this example of the invention the electrolyte solution 3 is contained within an electrically conducting container 4 which is preferably produced of a metallic material such as aluminium or stainless steel and will preferably be retained upon a non-conducting surface. In the example shown in FIG. 1 the electrical conductor 5 takes the form of a metallic tube which surrounds the package 1 and is connected electrically to one terminal of an AC electrical power source 6. The other terminal of the electrical power source 6 is connected to a resistor 7 which is in turn connected to the electrically conducting container 4.

In conducting the method according to the invention, once the components of the circuit are in place and the power source is switched on, a measurement of voltage drop across the resistor 7 or current through the circuit is taken. This measurement may for example be taken using a volt meter, an ammeter or by utilising an oscilloscope, as will be understood by persons skilled in the art. By conducting the detection method on products of the same size and shape and containing the same contents, which are both perforated and unperforated in the portion of the package to be tested, and having perforations of different size and configuration it will be possible to obtain readings for the voltage drop across the resistor or circuit current under a number of conditions. By following this approach it is possible to determine a threshold value of voltage drop which, if exceeded, indicates the presence of a perforation within the portion of the package being tested. Similarly a circuit current above a particular threshold will indicate the presence of a perforation. It may be appropriate to utilise routine statistical methods to assist in determining statistically significant threshold values for voltage drop or circuit current which are indicative of perforation.

It is believed that the method according to the invention operates by virtue of the contacts between the electrical conductor and the package, and the electrolyte and the package, acting as capacitors in conjunction with the electrically conducting package contents. When there is a perforation within the portion of the package being tested there is a change in capacitance between the package contents and the electrolyte solution causing an increase in the voltage drop across the resistor or change in current (relative to a non-perforated package) which can be detected.

The invention will now be further described with reference to the following non-limiting example:

### EXAMPLE

The inventive method was applied to a cylindrically-shaped package made of flexible non-conducting plastic film which contained solid processed food which had been hermetically sealed with a heat seal and wire ties. The package contained no head space or air pockets.

Aqueous sodium chloride (approximately 0.15 M) was used as the electrolyte solution. A cylindrically-shaped aluminum plate, conforming to the cylindrical shape of the package and which covered approximately 83% of the non-immersed surface of the package, was placed in contact with the package. A power source which supplied 2.4 Volts RMS at 10.1 kHz was used with a resistor of 510 Ohms inserted within the circuit between the power source and the electrolyte solution.

The amplitude of the voltage drop was first measured using a package with no perforations. The measurement was then repeated in an identical fashion on the same package, after the portion of the package being tested was punctured with a 0.6 mm diameter pin. The voltage drop across the resistor was increased by approximately 162% after the pin hole had been made.

The actual voltage drop across the resistor obtained for both perforated and non-perforated packages is shown in table 1, alongside comparative results obtained using the prior art method of Yasumoto et al, when utilising the same parameters as referred to in the example above (ie. 0.15 M NaCl solution, aluminium electrodes covering 83% of non-immersed surface, 2.4 Volt RMS power at 10.1 kHz, resistor of 510 Ohms—non-perforated package and perforated package in equivalent position with 0.6 mm diameter pin).

TABLE 1

Voltage drop across resistor

| | UZ,14/29 (RMS mV) | |
|---|---|---|
| | Example 1 | Yasumoto |
| Non-perforated | 122 | 188 |
| Perforated | 320 | 228 |

It is to be understood that the present invention has been described by way of example only and that modifications and/or alterations thereto which would be apparent to a person skilled in the art based upon the disclosure herein are also considered to fall within the spirit and scope of the invention.

1. A method of detecting perforations in a portion of a substantially electrically non-conducting package which contains an electrically conducting material, the method comprising the steps of:
(a) immersing the portion of the package to be tested in an electrolyte solution;
(b) contacting a substantial amount of non-immersed package surface with an electrical conductor;
(c) electrically connecting a first terminal of an AC electrical power source to the electrical conductor and a second terminal to the electrolyte solution and including a resistor in electrical connection either between the first terminal and the electrical conductor or between the second terminal and the electrolyte solution;
(d) measuring voltage reduction across the resistor or measuring current flow and comparing it with a threshold value such that if the voltage reduction or current exceeds the threshold value, perforation of the tested portion of the package is indicated.

2. The method according to claim 1 wherein the electrical conductor contacts at least about 15% of the non-immersed package surface.

3. The method according to claim 1 wherein the electrical conductor contacts at least about 30% of the non-immersed package surface.

4. The method according to claim 1 wherein the electrical conductor contacts at least about 50% of the non-immersed package surface.

5. The method according to claim 1 wherein the electrical conductor contacts at least about 65% of the non-immersed package surface.

6. The method according to claim 1 wherein the electrical conductor contacts at least about 80% of the non-immersed package surface.

7. The method according to any one of claims 1 to 6 wherein the electrical conductor is metallic and conforms in shape to at least part of the non-immersed package surface.

8. The method according to any one of claims 1 to 6 wherein the electrical conductor is an electrically conducting brush with bristles arranged to contact at least part of the non-immersed package surface.

9. The method according to any one of claims 1 to 6 wherein the electrical conductor is an electrically conducting paste, gel or liquid which can be applied to, or placed in contact with, at least part of the non-immersed package surface.

10. The method according to any one of claims 1 to 9 wherein the electrolyte solution is retained in an electrically conducting container and wherein the electrical connection between the second terminal, optionally via the resistor, is via the container.

11. The method according to any one of claims 1 to 10 wherein the electrolyte solution is an aqueous solution comprising one or more of sodium ions, chloride ions, hydrogen ions, hydroxide ions, potassium ions, calcium ions, magnesium ions, iron ions, carbonate ions, nitrate ions, nitrite ions, fluoride ions, aluminum ions, phosphate ions and/or sulfate ions.

12. The method according to any one of claims 1 to 11 wherein the electrical power source supplies between about 0.5 Volts RMS and about 50 Volts RMS at a frequency of between about 0.5 kHz and about 50 kHz with resistance of the resistor being between about 50 Ohms and about 2000 Ohms.

13. The method according to any one of claims 1 to 11 wherein the electrical power source supplies between about 1 Volt RMS and about 10 Volts RMS at a frequency of between about 1 kHz and about 15 kHz with resistance of the resistor being between about 250 Ohms and about 750 Ohms.

14. The method according to any one of claims 1 to 13 substantially as hereinbefore described with reference to the FIGURE and/or example.
